(19) United States
(12) Patent Application Publication
(10) Pub. No.: US 2026/0087602 A1
(43) Pub. Date: Mar. 26, 2026

(54) Image Artifact Mitigation in Video Encoding

(71) Applicant: Apple Inc., Cupertino, CA (US)

(72) Inventor: Jae Young Park, Los Gatos, CA (US)

(21) Appl. No.: 18/967,320

(22) Filed: Dec. 3, 2024

Related U.S. Application Data
(60) Provisional application No. 63/699,704, filed on Sep. 26, 2024.

(51) Int. Cl. G06T 5/70; G06T 5/20; G06T 5/50; G06T 7/215; G06T 7/90; H04N 19/105; H04N 19/139; H04N 19/172

(52) U.S. Cl. CPC G06T 5/70; G06T 5/20; G06T 5/50; G06T 7/215; G06T 7/90; H04N 19/105; H04N 19/139; H04N 19/172; G06T 2207/10016; G06T 2207/20016; G06T 2207/20182

(57) ABSTRACT

Embodiments described relate to adjusting one or more pixel values in a region corresponding to an image artifact based on one or more spatial characteristics and one or more temporal characteristics to reduce or eliminate the image artifact. An electronic device may employ spatio-temporal filtering circuitry that includes spatial adjustment circuitry, temporal adjustment circuitry, and/or fuse circuitry. The spatial adjustment circuitry may perform a spatial adjustment of image data in the region of the image frame. Moreover, the temporal adjustment circuitry may perform a temporal adjustment of the image data in the region of the image frame. The fuse circuitry may then merge the spatially adjusted image data and the temporally adjusted image data in the region of the image frame.

### CROSS-REFERENCE TO RELATED APPLICATIONS

This application claims priority to U.S. Provisional Application No. 63/699,704, filed Sep. 26, 2024, which is incorporated by reference herein in its entirety.

### BACKGROUND

The present disclosure relates generally to mitigating (e.g., reducing) or eliminating image artifacts (e.g., green ghost image artifacts) in a region of an image frame by adjusting one or more pixel values in the region.

When a camera records a video, external light sources may reflect or refract off a cover glass or lens of the camera, which may produce a number of off-color spots (e.g., green ghost image artifacts) in the video. Further, the off-color spots may appear to shift across the frame of the video over time. As such, the off-color spots may produce undesirable image artifacts in video recordings.

### SUMMARY

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

This disclosure is generally directed to adjusting one or more pixel values in a region corresponding to an image artifact based on one or more spatial characteristics and one or more temporal characteristics to reduce or eliminate the image artifact. An electronic device may include spatio-temporal filtering circuitry that includes spatial adjustment circuitry, temporal adjustment circuitry, and/or fuse circuitry. The spatial adjustment circuitry may adjust the one or more pixel values in the region corresponding to the image artifact based on the one or more spatial characteristics. For example, the one or more spatial characteristics may include one or more source pixel values, one or more boundary pixel values, and/or a base color weight. The spatial adjustment circuitry may then output one or more spatially adjusted pixel values.

The temporal adjustment circuitry may receive the one or more spatially adjusted pixel values from the spatial mitigation circuitry. Further, the temporal adjustment circuitry may adjust the one or more spatially adjusted pixel values based on one or more temporal characteristics. For example, the temporal characteristics may include one or more motion compensated pixel values of a first previous frame and one or more motion compensated pixel values of a second previous frame. The temporal adjustment circuitry may adjust the one or more spatially adjusted pixel values using a temporal filter to output one or more temporally adjusted pixel values. The fuse circuitry may then receive the one or more spatially adjusted pixel values and the one or more temporally adjusted pixel values. Moreover, the fuse circuitry may merge (e.g., combine) the one or more spatially adjusted pixel values with the one or more temporally adjusted pixel values to output the merged spatio-temporally adjusted pixel values to reduce or eliminate the image artifact.

### BRIEF DESCRIPTION OF THE DRAWINGS

Various aspects of this disclosure may be better understood upon reading the following detailed description and upon reference to the drawings in which:

FIG. 1 is a block diagram of an electronic device, according to embodiments of the present disclosure;

FIG. 2 is a front view of a handheld device representing an example of the electronic device of FIG. 1, according to embodiments of the present disclosure;

FIG. 3 is a front view of another handheld device representing another example of the electronic device of FIG. 1, according to embodiments of the present disclosure;

FIG. 4 is a perspective view of a notebook computer representing an example of the electronic device of FIG. 1, according to embodiments of the present disclosure;

FIG. 5 illustrates front and side views of a wearable electronic device representing another example of the electronic device of FIG. 1, according to embodiments of the present disclosure;

FIG. 6 is a block diagram of a portion of the electronic device of FIG. 1 including a video encoding system, according to embodiments of the present disclosure;

FIG. 7 is an example illustration of image content depicting an image artifact that is less visible on a display of the electronic device of FIG. 1 after display pixel adjustment, according to embodiments of the present disclosure;

FIG. 8 is an example illustration of the image content depicting the image artifact with a bounding box, according to embodiments of the present disclosure;

FIG. 9 is an example illustration of the bounding box of FIG. 8, one or more boundary pixel values, and one or more edge pixel values, according to embodiments of the present disclosure;

FIG. 10 is a block diagram of a spatio-temporal filtering pipeline of the video encoding system of FIG. 6, according to embodiments of the present disclosure;

FIG. 11 is a block diagram of spatio-temporal filtering circuitry of the spatio-temporal filtering pipeline of FIG. 10, according to embodiments of the present disclosure; and

FIG. 12 is a flowchart of a method for adjusting one or more pixel values based on one or more spatial characteristics and one or more temporal characteristics, according to embodiments of the present disclosure.

### DETAILED DESCRIPTION OF SPECIFIC EMBODIMENTS

The present disclosure generally relates to adjusting one or more pixel values in a region corresponding to an image artifact based on one or more spatial characteristics and one or more temporal characteristics to reduce or eliminate the image artifact. An electronic device may employ spatio-temporal filtering circuitry that includes spatial adjustment circuitry, temporal adjustment circuitry, and/or fuse circuitry. The spatial adjustment circuitry may perform a spatial adjustment of image data in the region of the image frame. Moreover, the temporal adjustment circuitry may perform a temporal adjustment of the image data in the region of the image frame. The fuse circuitry may then merge the spatially adjusted image data and the temporally adjusted image data in the region of the image frame. The spatio-temporal filtering circuitry may then output the spatio-temporally adjusted image data to reduce or eliminate the image artifact in the region of the image frame.

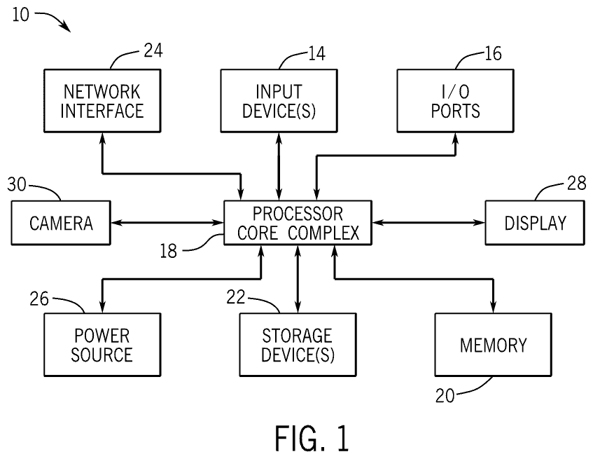

FIG. 1 is a block diagram of an electronic device 10, according to embodiments of the present disclosure. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes one or more input devices 14, one or more input/output (I/O) ports 16, a processor core complex 18 having one or more processing circuitry(s) or processing circuitry cores, local memory 20, a main memory storage device 22, a network interface 24, a power source 26 (e.g., power supply), an electronic display 28, and a camera 30. The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

In some embodiments, the electronic device 10 may include two or more processor core complexes 18. The embodiments discussed herein may be associated with and/or similarly applicable to embodiments of the electronic device 10 including a single processor core complex 18 and embodiments of the electronic device 10 including two or more processor core complexes 18. For example, one or more of the processor core complexes 18 may include multiple cores including one or more processors, one or more controller, and/or one or more state machine circuits. Each of the two or more processor core complexes 18 may perform some functions or provide at least a portion of control signals and/or instructions discussed herein. In specific embodiments, some of the two or more processor core complexes 18 may be coupled together and may perform certain functions discussed herein individually or in collaboration with each other.

The processor core complex 18 is operably coupled with local memory 20 and the main memory storage device 22. Thus, the processor core complex 18 may execute instructions stored in local memory 20 and/or the main memory storage device 22 to perform operations, such as generating or transmitting image data to display on the electronic display 28 and/or receiving image data generated by the camera 30. As such, the processor core complex 18 may include one or more processors, one or more general purpose microprocessors, one or more application specific integrated circuits (ASICs), one or more field programmable gate arrays (FPGAs), or any combination thereof. In some embodiments, a system on a chip (SoC) may include the processor core complex 18, among other things.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to one or more components in the electronic device 10, such as the processor core complex 18, the electronic display 28, and/or the camera 30. For example, the power source 26 may include a power supply rail and/or a ground terminal coupled to the one or more components in the electronic device 10, such as the processor core complex 18, the electronic display 28, and/or the camera 30 to provide the electrical power. Thus, the power source 26 may include any suitable source of energy, such as a rechargeable lithium polymer (Li-poly) battery or an alternating current (AC) power converter.

The processor core complex 18 may generate and/or output (e.g., provide) raw data or image data. For example, the display 28 may receive and/or display the raw data or the image data. The I/O ports 16 may enable the electronic device 10 to interface with other electronic devices. For example, when a portable storage device is connected, the I/O port 16 may enable the processor core complex 18 to communicate data with the portable storage device. The input devices 14 may enable user interaction with the electronic device 10, for example, by receiving user inputs via a button, a keyboard, a mouse, a trackpad, or the like. The input device 14 may include touch-sensing components in the electronic display 28. The touch sensing components may receive user inputs by detecting occurrence or position of an object touching the surface of the electronic display 28.

The electronic display 28 may include driver circuitry (e.g., display driver circuitry) and/or a display panel including pixel circuitry with an array of display pixels. Moreover, the driver circuitry may include various circuitry to provide one or more stable positive and/or negative supply voltages, such as the power supply rail and/or the ground terminal. Image data for display on the electronic display 28 may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 28 may display frames based on image data generated by the processor core complex 18, or the electronic display 28 may display frames based on image data received via the network interface 24, an input device, or an I/O port 16.

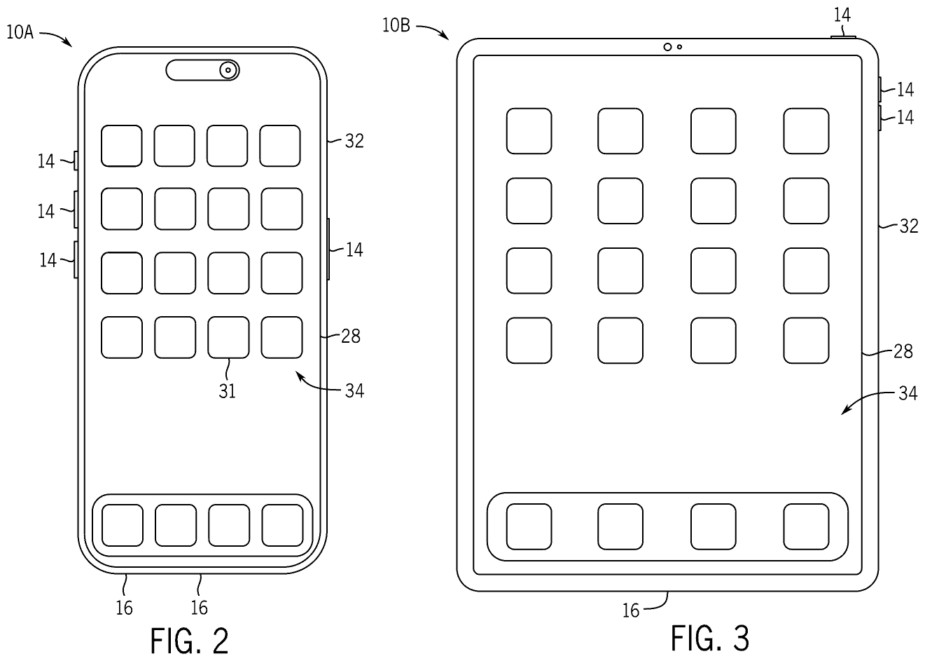

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any IPHONE® model available from Apple Inc.

The handheld device 10A includes an enclosure 32 (e.g., housing). The enclosure 32 may protect interior components from physical damage or shield them from electromagnetic interference, such as by surrounding the electronic display 28. The electronic display 28 may display a graphical user interface (GUI) 34 having an array of icons. When an icon 31 is selected either by an input device 14 or a touch-sensing component of the electronic display 28, an application program may launch.

The input devices 14 may be accessed through openings in the enclosure 32. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

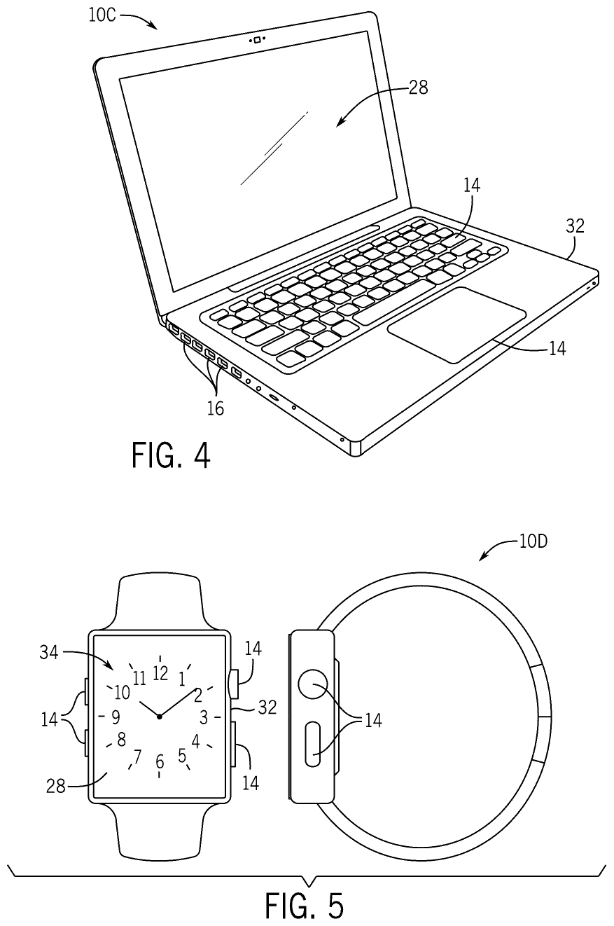

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc.

As depicted, the tablet device 10B, the computer 10C, and the watch 10D each also includes an electronic display 28, input devices 14, I/O ports 16, and an enclosure 32. The electronic display 28 may display a GUI 34. As shown in FIG. 5, the GUI 34 may show a visualization of a clock. When the visualization is selected either by the input device 14 or a touch-sensing component of the electronic display 28, an application program may launch, such as to transition the GUI 34 to presenting the icons 31 discussed with respect to FIGS. 2 and 3.

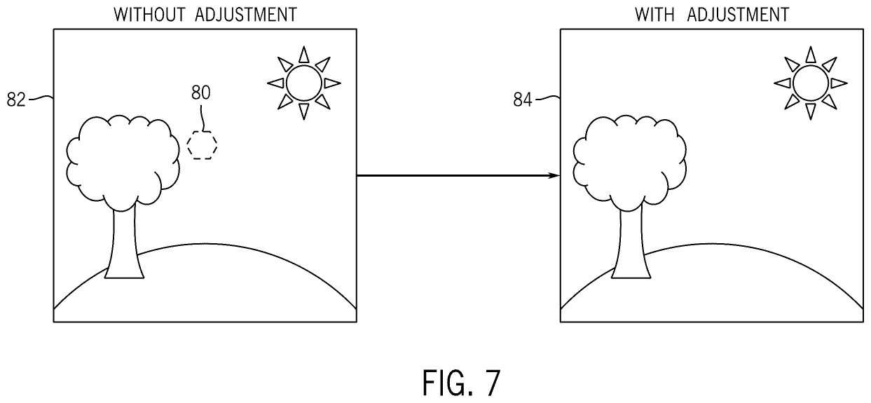

An example of a portion of an electronic device 10, which includes a video encoding system 38, is shown in FIG. 7. The video encoding system 38 may be implemented via circuitry, for example, packaged as a system-on-chip (SoC), such as included in the processor core complex 18 and/or separate image processing circuitry of the electronic device 10. In an embodiment, the image processing circuitry of the electronic device 10 may be a part of the camera 30 or the processor core complex 18. Additionally or alternatively, the video encoding system 38 may be implemented in one or more other processing units, other processing circuitry, or any combination thereof.

The video encoding system 38 may be communicatively coupled to a controller 40. The controller 40 may generally control operation of the video encoding system 38. Although depicted as a single controller 40, in other embodiments, one or more separate controllers 40 may be used to control operation of the video encoding system 38. Additionally, in some embodiments, the controller 40 may be implemented in the video encoding system 38, for example, as a dedicated video encoding controller.

The controller 40 may include a controller processor 42 and controller memory 44. In some embodiments, the controller processor 42 may execute instructions and/or process data stored in the controller memory 44 to control operation of the video encoding system 38. In other embodiments, the controller processor 42 may be hardwired with instructions that control operation of the video encoding system 38 (e.g., as a finite state machine). Additionally, in some embodiments, the controller processor 42 may be included in the processor core complex 18, the image processing circuitry, and/or separate processing circuitry (e.g., in the electronic display 28), and the controller memory 44 may be included in local memory 21, main memory storage device 22, and/or a separate, tangible, non-transitory computer-readable medium (e.g., in the electronic display 28).

The video encoding system 38 may include direct memory access (DMA) circuitry 39. In some embodiments, the DMA circuitry 39 may communicatively couple the video encoding system 38 to an image sensor, such as external memory that stores source image data, for example, generated by the image sensor or received via the network interface 24 or the I/O ports 16.

To facilitate generating encoded image data, the video encoding system 38 may include multiple parallel pipelines. For example, in the depicted embodiment, the video encoding system 38 includes a low-resolution pipeline 46, a main encoding pipeline 48, and a transcode pipeline 50. The main encoding pipeline 48 may encode source image data using prediction techniques (e.g., inter prediction techniques or intra prediction techniques), and the transcode pipeline 50 may subsequently entropy encode syntax elements that indicate encoding parameters (e.g., quantization coefficient, inter prediction mode, and/or intra prediction mode) used to prediction encode the image data.

To facilitate prediction encoding source image data, the main encoding pipeline 48 may perform various functions. To simplify discussion, the functions are divided between various blocks (e.g., circuitry or modules) in the main encoding pipeline 48. In the depicted embodiment, the main encoding pipeline 48 includes a motion estimation block 52, an inter prediction block 54, an intra prediction block 56, a mode decision block 58, a reconstruction block 60, and a filter block 62.

The motion estimation block 52 is communicatively coupled to the DMA circuitry 39. In this manner, the motion estimation block 52 may receive source image data via the DMA circuitry 39, which may include a luma component (e.g., Y) and two chroma components (e.g., Cr and Cb). In some embodiments, the motion estimation block 52 may process one coding unit, including one luma coding block and two chroma coding blocks, at a time. As used herein a “luma coding block” is intended to describe the luma component of a coding unit and a “chroma coding block” is intended to describe a chroma component of a coding unit.

A luma coding block may be the same resolution as the coding unit. On the other hand, the chroma coding blocks may vary in resolution based on chroma sampling format. For example, using a 4:4:4 sampling format, the chroma coding blocks may be the same resolution as the coding unit. However, the chroma coding blocks may be half (e.g., half resolution in the horizontal direction) the resolution of the coding unit when a 4:2:2 sampling format is used and a quarter (e.g., half resolution in the horizontal direction and half resolution in the vertical direction) the resolution of the coding unit when a 4:2:0 sampling format is used.

As described above, a coding unit may include one or more prediction units, which may each be encoded using the same prediction technique, but different prediction modes. Each prediction unit may include one luma prediction block and two chroma prediction blocks. As used herein a “luma prediction block” is intended to describe the luma component of a prediction unit and a “chroma prediction block” is intended to describe a chroma component of the prediction unit. In some embodiments, the luma prediction block may be the same resolution as the prediction unit. On the other hand, similar to the chroma coding blocks, the chroma prediction blocks may vary in resolution based on chroma sampling format.

Based at least in part on the one or more luma prediction blocks, the motion estimation block 52 may determine candidate inter prediction modes that can be used to encode a prediction unit. An inter prediction mode may include a motion vector and a reference index to indicate location (e.g., spatial position and temporal position) of a reference sample relative to a prediction unit. More specifically, the reference index may indicate display order of a reference image frame corresponding with the reference sample relative to a current image frame corresponding with the prediction unit. Additionally, the motion vector may indicate position of the reference sample in the reference image frame relative to position of the prediction unit in the current image frame.

To determine a candidate inter prediction mode, the motion estimation block 52 may search reconstructed luma image data, which may be previously generated by the reconstruction block 60 and stored in internal memory 53 (e.g., reference memory) of the video encoding system 38. For example, the motion estimation block 52 may determine a reference sample for a prediction unit by comparing its luma prediction block to the luma of reconstructed image data. In some embodiments, the motion estimation block 52 may determine how closely a prediction unit and a reference sample match based on a match metric. In some embodiments, the match metric may be the sum of absolute difference (SAD) between a luma prediction block of the prediction unit and luma of the reference sample. Additionally or alternatively, the match metric may be the sum of absolute transformed difference (SATD) between the luma prediction block and luma of the reference sample. When the match metric is above a match threshold, the motion estimation block 52 may determine that the reference sample and the prediction unit do not closely match. On the other hand, when the match metric is below the match threshold, the motion estimation block 52 may determine that the reference sample and the prediction unit are similar.

After a reference sample that sufficiently matches the prediction unit is determined, the motion estimation block 52 may determine location of the reference sample relative to the prediction unit. For example, the motion estimation block 52 may determine a reference index to indicate a reference image frame, which contains the reference sample, relative to a current image frame, which contains the prediction unit. Additionally, the motion estimation block 52 may determine a motion vector to indicate position of the reference sample in the reference frame relative to position of the prediction unit in the current frame. In some embodiments, the motion vector may be expressed as (mvX, mvY), where mvX is horizontal offset and mvY is a vertical offset between the prediction unit and the reference sample. The values of the horizontal and vertical offsets may also be referred to as x-components and y-components, respectively.

In this manner, the motion estimation block 52 may determine candidate inter prediction modes (e.g., reference index and motion vector) for one or more prediction units in the coding unit. The motion estimation block 52 may then input candidate inter prediction modes to the inter prediction block 54. Based at least in part on the candidate inter prediction modes, the inter prediction block 54 may determine luma prediction samples (e.g., predictions of a prediction unit).

The inter prediction block 54 may determine a luma prediction sample by applying motion compensation to a reference sample indicated by a candidate inter prediction mode. For example, the inter prediction block 54 may apply motion compensation by determining luma of the reference sample at fractional (e.g., quarter or half) pixel positions. The inter prediction block 54 may then input the luma prediction sample and corresponding candidate inter prediction mode to the mode decision block 58 for consideration. In some embodiments, the inter prediction block 54 may sort the candidate inter prediction modes based on associated mode cost and input only a specific number to the mode decision block 58.

The mode decision block 58 may also consider one or more candidate intra predictions modes and corresponding luma prediction samples output by the intra prediction block 56. The main encoding pipeline 48 may be capable of implementing multiple (e.g., 13, 17, 25, 29, 35, 38, or 43) different intra prediction modes to generate luma prediction samples based on adjacent pixel image data. Thus, in some embodiments, the intra prediction block 56 may determine a candidate intra prediction mode and corresponding luma prediction sample for a prediction unit based at least in part on luma of reconstructed image data for adjacent (e.g., top, top right, left, or bottom left) pixel values, which may be generated by the reconstruction block 60.

For example, utilizing a vertical prediction mode, the intra prediction block 56 may set each column of a luma prediction sample equal to reconstructed luma of a pixel directly above the column. Additionally, utilizing a DC prediction mode, the intra prediction block 56 may set a luma prediction sample equal to an average of reconstructed luma of pixel values adjacent the prediction sample. The intra prediction block 56 may then input candidate intra prediction modes and corresponding luma prediction samples to the mode decision block 58 for consideration. In some embodiments, the intra prediction block 56 may sort the candidate intra prediction modes based on associated mode cost and input only a specific number to the mode decision block 58.

The mode decision block 58 may determine encoding parameters to be used to encode the source image data (e.g., a coding unit). In some embodiments, the encoding parameters for a coding unit may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction units, number of transform units in the coding unit, size of the transform units, whether to split the coding unit into smaller coding units, or any combination thereof.

To facilitate determining the encoding parameters, the mode decision block 58 may determine whether the image frame is an I-frame, a P-frame, or a B-frame. In I-frames, source image data is encoded only by referencing other image data used to display the same image frame. Accordingly, when the image frame is an I-frame, the mode decision block 58 may determine that each coding unit in the image frame may be prediction encoded using intra prediction techniques.

On the other hand, in a P-frame or B-frame, source image data may be encoded by referencing image data used to display the same image frame and/or a different image frames. More specifically, in a P-frame, source image data may be encoding by referencing image data associated with a previously coded or transmitted image frame. Additionally, in a B-frame, source image data may be encoded by referencing image data used to code two previous image frames. More specifically, with a B-frame, a prediction sample may be generated based on prediction samples from two previously coded frames; the two frames may be different from one another or the same as one another. Accordingly, when the image frame is a P-frame or a B-frame, the mode decision block 58 may determine that each coding unit in the image frame may be prediction encoded using either intra techniques or inter techniques.

Although using the same prediction technique, the configuration of luma prediction blocks in a coding unit may vary. For example, the coding unit may include a variable number of luma prediction blocks at variable locations within the coding unit, which each uses a different prediction mode. As used herein, a “prediction mode configuration” is intended to describe the number, size, location, and prediction mode of luma prediction blocks in a coding unit. Thus, the mode decision block 58 may determine a candidate inter prediction mode configuration using one or more of the candidate inter prediction modes received from the inter prediction block 54. Additionally, the mode decision block 58 may determine a candidate intra prediction mode configuration using one or more of the candidate intra prediction modes received from the intra prediction block 56.

Since a coding unit may utilize the same prediction technique, the mode decision block 58 may determine prediction technique for the coding unit by comparing rate-distortion metrics (e.g., costs) associated with the candidate prediction mode configurations and/or a skip mode. In some embodiments, the rate-distortion metric may be determined by summing a first product obtained by multiplying an estimated rate that indicates number of bits expected to be used to indicate encoding parameters and a first weighting factor for the estimated rate and a second product obtained by multiplying a distortion metric (e.g., sum of squared difference) resulting from the encoding parameters and a second weighting factor for the distortion metric. The first weighting factor may be a Lagrangian multiplier, and the first weighting factor may depend on a quantization parameter associated with image data being processed.

The distortion metric may indicate amount of distortion in decoded image data expected to be caused by implementing a prediction mode configuration. Accordingly, in some embodiments, the distortion metric may be a sum of squared difference (SSD) between a luma coding block (e.g., source image data) and reconstructed luma image data received from the reconstruction block 60. Additionally or alternatively, the distortion metric may be a sum of absolute transformed difference (SATD) between the luma coding block and reconstructed luma image data received from the reconstruction block 60.

In some embodiments, prediction residuals (e.g., differences between source image data and prediction sample) resulting in a coding unit may be transformed as one or more transform units. As used herein, a “transform unit” is intended to describe a sample within a coding unit that is transformed together. In some embodiments, a coding unit may include a single transform unit. In other embodiments, the coding unit may be divided into multiple transform units, which is each separately transformed.

Additionally, the estimated rate for an intra prediction mode configuration may include expected number of bits used to indicate intra prediction technique (e.g., coding unit overhead), expected number of bits used to indicate intra prediction mode, expected number of bits used to indicate a prediction residual (e.g., source image data-prediction sample), and expected number of bits used to indicate a transform unit split. On the other hand, the estimated rate for an inter prediction mode configuration may include expected number of bits used to indicate inter prediction technique, expected number of bits used to indicate a motion vector (e.g., motion vector difference), and expected number of bits used to indicate a transform unit split. Additionally, the estimated rate of the skip mode may include number of bits expected to be used to indicate the coding unit when prediction encoding is skipped.

The mode decision block 58 may select a prediction mode configuration or skip mode with the lowest associated rate-distortion metric for a coding unit. In this manner, the mode decision block 58 may determine encoding parameters for a coding unit, which may include prediction technique (e.g., intra prediction techniques or inter prediction techniques) for the coding unit, number of prediction units in the coding unit, size of the prediction units, prediction mode (e.g., intra prediction modes or inter prediction modes) for each of the prediction unit, number of transform units in the coding block, size of the transform units, whether to split the coding unit into smaller coding units, or any combination thereof.

To facilitate improving perceived image quality resulting from decoded image data, the main encoding pipeline 48 may then mirror decoding of encoded image data. To facilitate, the mode decision block 58 may output the encoding parameters and/or luma prediction samples to the reconstruction block 60. Based on the encoding parameters and reconstructed image data associated with one or more adjacent blocks of image data, the reconstruction block 60 may reconstruct image data.

More specifically, the reconstruction block 60 may generate the luma component of reconstructed image data. In some embodiments, the reconstruction block 60 may generate reconstructed luma image data by subtracting the luma prediction sample from luma of the source image data to determine a luma prediction residual. The reconstruction block 60 may then divide the luma prediction residuals into luma transform blocks as determined by the mode decision block 58, perform a forward transform and quantization on each of the luma transform blocks, and perform an inverse transform and quantization on each of the luma transform blocks to determine a reconstructed luma prediction residual. The reconstruction block 60 may then add the reconstructed luma prediction residual to the luma prediction sample to determine reconstructed luma image data. As described above, the reconstructed luma image data may then be fed back for use in other blocks in the main encoding pipeline 48, for example, via storage in internal memory 53 of the main encoding pipeline 48. Additionally, the reconstructed luma image data may be output to the filter block 62.

The reconstruction block 60 may also generate both chroma components of reconstructed image data. In some embodiments, chroma reconstruction may be dependent on sampling format. For example, when luma and chroma are sampled at the same resolution (e.g., 4:4:4 sampling format), the reconstruction block 60 may utilize the same encoding parameters as used to reconstruct luma image data. In such embodiments, for each chroma component, the reconstruction block 60 may generate a chroma prediction sample by applying the prediction mode configuration determined by the mode decision block 58 to adjacent pixel image data.

The reconstruction block 60 may then subtract the chroma prediction sample from chroma of the source image data to determine a chroma prediction residual. Additionally, the reconstruction block 60 may divide the chroma prediction residual into chroma transform blocks as determined by the mode decision block 58, perform a forward transform and quantization on each of the chroma transform blocks, and perform an inverse transform and quantization on each of the chroma transform blocks to determine a reconstructed chroma prediction residual. The chroma reconstruction block may then add the reconstructed chroma prediction residual to the chroma prediction sample to determine reconstructed chroma image data, which may be input to the filter block 62.

However, in other embodiments, chroma sampling resolution may vary from luma sampling resolution, for example when a 4:2:2 or 4:2:0 sampling format is used. In such embodiments, encoding parameters determined by the mode decision block 58 may be scaled. For example, when the 4:2:2 sampling format is used, size of chroma prediction blocks may be scaled in half horizontally from the size of prediction units determined in the mode decision block 58. Additionally, when the 4:2:0 sampling format is used, size of chroma prediction blocks may be scaled in half vertically and horizontally from the size of prediction units determined in the mode decision block 58. In a similar manner, a motion vector determined by the mode decision block 58 may be scaled for use with chroma prediction blocks.

To improve quality of decoded image data, the filter block 62 may filter the reconstructed image data (e.g., reconstructed chroma image data and/or reconstructed luma image data). In some embodiments, the filter block 62 may perform deblocking and/or sample adaptive offset (SAO) functions. For example, the filter block 62 may perform deblocking on the reconstructed image data to reduce perceivability of blocking artifacts that may be introduced. Additionally, the filter block 62 may perform a sample adaptive offset function by adding offsets to portions of the reconstructed image data.

To enable decoding, encoding parameters used to generate encoded image data may be communicated to a decoding device. In some embodiments, the encoding parameters may include the encoding parameters determined by the mode decision block 58 (e.g., prediction unit configuration and/or transform unit configuration), encoding parameters used by the reconstruction block 60 (e.g., quantization coefficients), and encoding parameters used by the filter block 62. To facilitate communication, the encoding parameters may be expressed as syntax elements. For example, a first syntax element may indicate a prediction mode (e.g., inter prediction mode or intra prediction mode), a second syntax element may indicate a quantization coefficient, a third syntax element may indicate configuration of prediction units, and a fourth syntax element may indicate configuration of transform units.

The transcode pipeline 50 may then convert a bin stream, which is representative of syntax elements generated by the main encoding pipeline 48, to a bit stream with one or more syntax elements represented by a fractional number of bits. In some embodiments, the transcode pipeline 50 may compress bins from the bin stream into bits using arithmetic coding. To facilitate arithmetic coding, the transcode pipeline 50 may determine a context model for a bin, which indicates probability of the bin being a “1” or “0,” based on previous bins. Based on the probability of the bin, the transcode pipeline 50 may divide a range into two sub-ranges. The transcode pipeline 50 may then determine an encoded bit such that it falls within one of two sub-ranges to select the actual value of the bin. In this manner, multiple bins may be represented by a single bit, thereby improving encoding efficiency (e.g., reduction in size of source image data). After entropy encoding, the transcode pipeline 50, may transmit the encoded image data to an output for transmission, storage, and/or display.

Additionally, the video encoding system 38 may include a spatio-temporal filtering pipeline 66, which may perform pixel adjustment operations and perform spatio-temporal filtering operations. In some embodiments, the spatio-temporal filtering pipeline 66 may facilitate image artifact mitigation within the pipeline independently. For example, when the spatio-temporal filtering pipeline 66 is performing the image artifact mitigation, the spatio-temporal filtering pipeline 66 will not proceed to a next image frame until completion of a current image frame. As will be described in further detail below, the spatio-temporal filtering pipeline 66 may fetch source pixel values and reference pixel values from a luma cache and a chroma cache. In some embodiments, the spatio-temporal filtering pipeline 66 may also receive boundary pixel values and motion vectors. Moreover, as will be described in further detail below, the spatio-temporal filtering pipeline 66 may include spatio-temporal filtering circuitry to perform the pixel adjustment operations.

Furthermore, the video encoding system 38 may be communicatively coupled to an output. In this manner, the video encoding system 38 may output encoded (e.g., compressed) image data to such an output, for example, for storage and/or transmission. Thus, in some embodiments, the local memory 20, the main memory storage device 22, the network interface 24, the I/O ports 16, the controller memory 44, or any combination thereof may serve as an output.

As described above, the duration provided for encoding image data may be limited, particularly to enable real-time or near real-time display and/or transmission. To improve operational efficiency (e.g., operating duration and/or power consumption) of the main encoding pipeline 48, the low-resolution pipeline 46 may include a scaler block 65 and a low resolution motion estimation (ME) block 63. The scaler block 65 may receive image data and downscale the image data (e.g., a coding unit) to generate low-resolution image data. For example, the scaler block 65 may downscale a 32×32 coding unit to one-sixteenth resolution to generate an 8×8 downscaled coding unit. In other embodiments, such as embodiments in which the pre-processing circuitry 19 generates image data (e.g., low-resolution image data) from source image data, the low-resolution pipeline 46 may not include the scaler block 65, or the scaler block 65 may not be utilized to downscale image data.

The low resolution motion estimation block 63 may improve operational efficiency by initializing the motion estimation block 52 with candidate inter prediction modes, which may facilitate reducing searches performed by the motion estimation block 52. Additionally, the low resolution motion estimation block 63 may improve operational efficiency by generating global motion statistics that may be utilized by the motion estimation block 52 to determine a global motion vector.

At times, image content captured by the camera 30 may include an image artifact 80, such as a green ghost artifact or a reflection artifact. For example, external light sources may reflect or refract off a cover of glass or lens of the camera 30, which may cause light scattering within optical elements of the camera 30. Thus, without correction, the image artifact 80 may appear as brightly-colored spots or regions and/or shapes (e.g., rings, circles, halos) based on the reflection of light from the external light sources, as shown in image content 82. Such image artifacts may be mitigated or reduced as depicted in FIG. 7. Some techniques for determining that the image artifact 80 is present in the image content and/or receiving an indication of the image artifact 80 are described in more detail in U.S. patent application Ser. No. 18/825,924, entitled “Green Ghost Detection,” filed Sep. 5, 2024, which is hereby incorporated by reference in its entirely for all purposes.

Without display pixel adjustment, the image artifact 80 could appear when the image content 82 is displayed on the display 28. However, after display pixel adjustment, the image artifact 80 may be fully invisible or partially invisible as depicted by image content 84. After pixel adjustment for the image artifact 80 (e.g., in a region including the image artifact 80), the visibility of the image artifact 80 may be reduced by 50%, 80%, 90%, 100%, and the like. The process for display pixel adjustment will be described in greater detail below.

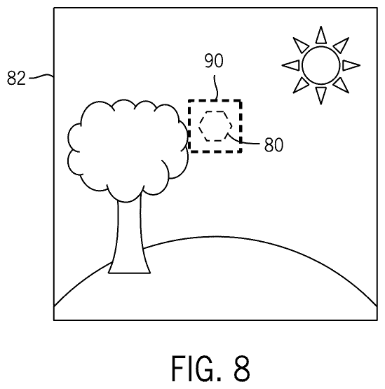

FIG. 8 is an example illustration of the image content 82 depicting the image artifact 80 with a bounding box 90 (e.g., a sub-frame or a region of an image frame of the image content 82). The bounding box 90 may be positioned in a region of the image content 82 including the image artifact 80. During display pixel adjustment, the spatio-temporal filtering circuitry may adjust one or more pixel values (e.g., one or more pixels) within the bounding box 90. In an embodiment, the bounding box 90 may be programmed, such as into registers of the electronic device 10, based on hierarchical motion estimation engines (e.g., of the motion estimation block 52) and/or the spatio-temporal filtering circuitry. The image artifact 80 processing may be based on an order specified in the registers of the electronic device 10. For example, up to thirty-two bounding boxes 90 or more may be programmed for one or more source pixel values and one or more reference pixel values. It should be noted that the bounding boxes 90 may be programmed in any suitable order.

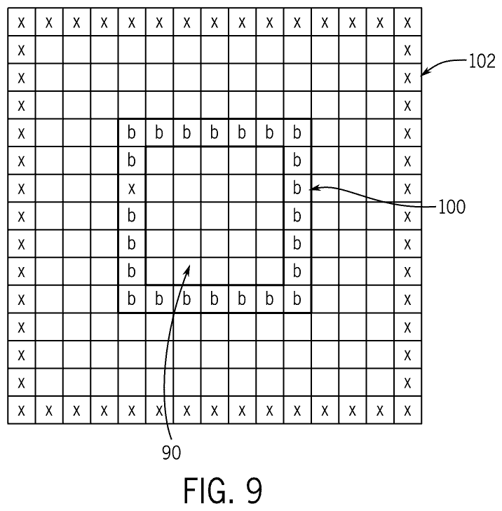

With the foregoing in mind, FIG. 9 is an example illustration of the bounding box 90 of FIG. 8, at least one or more boundary pixel values 100, and one or more edge pixel values 102 (e.g., extended edge pixel values). As illustrated in FIG. 9, in an example, the bounding box 90 may be a 5×5 pixel area (e.g., block, square). However, it should be noted that the bounding box 90 may be any suitable pixel size with any suitable dimensions (e.g., square, rectangle, octagon). As another example, the bounding box 90 may be within a range from a one by 1×1 pixel area to a 63×63 pixel area. Additionally or alternatively, the bounding box 90 may not contact (e.g., touch) one or more frame boundaries. Indeed, the bounding box 90 may be at least one scaled pixel away from the one or more frame boundaries. The bounding box 90 may enable the spatio-temporal filtering circuitry to adjust the one or more pixel values within the bounding box 90 without having to adjust one or more pixel values surrounding the bounding box within an image frame. Indeed, the bounding box 90 may define a start location and an end location for pixel adjustment by the spatio-temporal filtering circuitry.

Further, as illustrated in FIG. 9, the one or more boundary pixel values 100 may outline (e.g., frame, surround, be on the edge of) or be adjacent to the bounding box 90. The one or more boundary pixel values 100 may be received from hierarchical motion estimation engine circuitry. The electronic device 10 may store the one or more boundary pixel values 100 in the memory 20 (e.g., a Dynamic Random-Access Memory (DRAM)). Each of the one or more boundary pixel values 100 may include a luminance (e.g., brightness) component (Y), and two chroma components (CbCr), such as chrominance blue (e.g., blue-difference chroma) and chrominance red (e.g., chrominance red). The luminance component and the two chroma components may each include eight-bit components. In an embodiment, the one or more boundary pixel values 100 may also include a valid bit.

The one or more edge pixel values 102 (e.g., extended edge pixel values) may be a number of pixel values away from the bounding box 90. For example, as illustrated in FIG. 9, the one or more edge pixel values 102 may be five pixel values away from the bounding box 90. However, it should be noted that the one or more edge pixel values 102 may be any suitable number of pixel values away from the bounding box 90. For example, the one or more edge pixel values 102 may be fifteen pixel values away from the bounding box 90. The electronic device 10 may employ the one or more edge pixel values 102 in determining a maximum gradient. For example, the maximum gradient may correspond to a change in brightness or color from one pixel to another.

The maximum gradient may be a maximum of gradients of pixel values that are the number of pixel values away from the bounding box 90. Moreover, as an example, each maximum gradient may be a sum of twelve pair-wise horizontal pixel values and twelve pair-wise vertical pixel values absolute differences around each of the one or more edge pixel values 102. In an embodiment, when the bounding box 90 is near the one or more frame boundaries, a portion of the one or more edge pixel values 102 may be outside of the one or more frame boundaries. As such, the one or more edge pixel values 102 may be cropped (e.g., clipped, limited) to the one or more frame boundaries. In an embodiment, the electronic device 10 may store the one or more edge pixel values 102 contiguously (e.g., directly next to each other) in the memory 20.

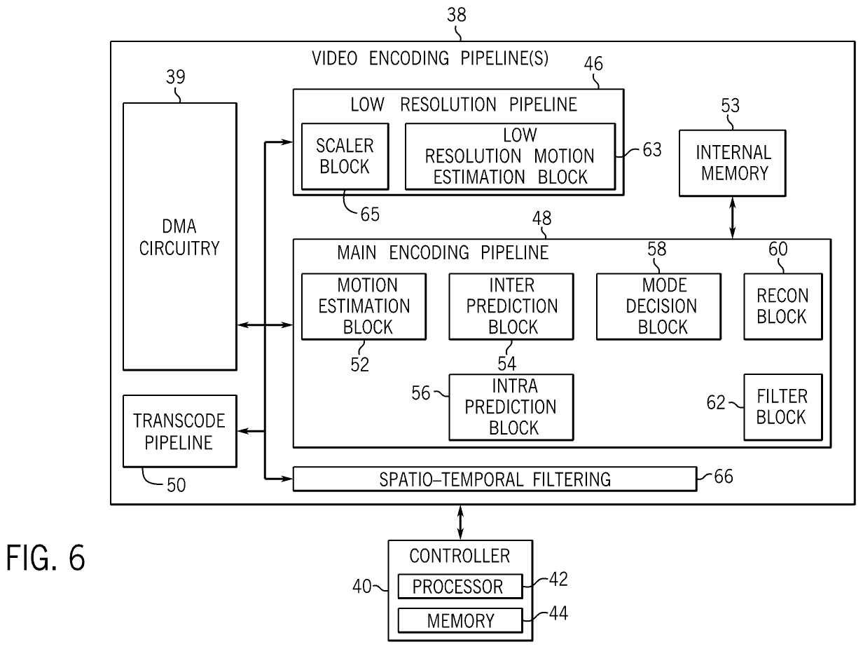

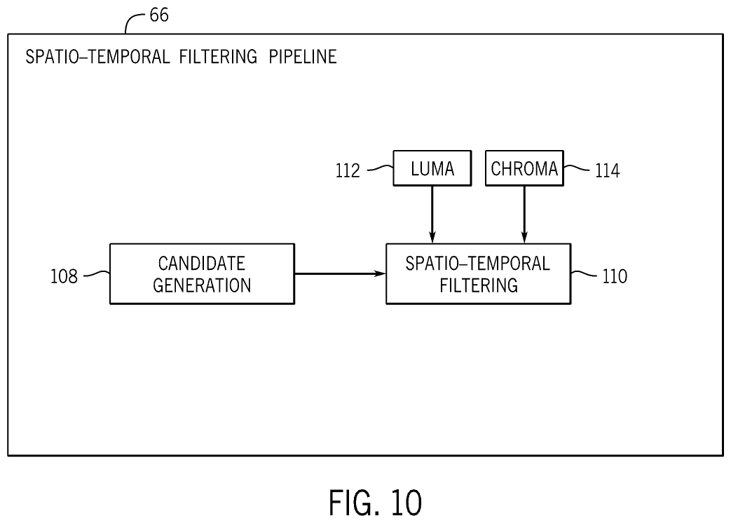

FIG. 10 is a block diagram of the spatio-temporal filtering pipeline 66 of the video encoding system of FIG. 6. The spatio-temporal filtering pipeline 66 may include candidate generation circuitry 108, spatio-temporal filtering circuitry 110, a luma cache 112, and/or a chroma cache 114. The candidate generation circuitry 108 may read from the DMA circuitry 39 using Address Generation Units (AGUs), neighbor data (e.g., above neighbor data), collocated data, motion vector candidates, and/or firmware data (e.g., previously coded frame data corresponding to current work unit coordinates, above and/or left neighbor firmware data). Further, the candidate generation circuitry 108 may receive the one or more boundary pixel values 100 and one or more hierarchical motion estimation vectors.

The candidate generation circuitry 108 may generate (e.g., produce) one or more candidates to be evaluated for a number of scaled pixel blocks (e.g., four by four pixel blocks) based on the one or more boundary pixel values 100 and/or the one or more hierarchical motion estimation vectors. For example, the one or more candidates may include zero vector candidates, spatial candidates, previous pass candidates (e.g., from a first previous frame and a second previous frame), motion vector candidates, homography estimation candidates, and/or or any other suitable candidates. Therefore, the candidate generation circuitry 108 may generate motion vector candidates to provide (e.g., transmit, send) to the spatio-temporal filtering circuitry 110. The candidate generation circuitry 108 may also provide the one or more boundary pixel values 100 to the spatio-temporal filtering circuitry 110.

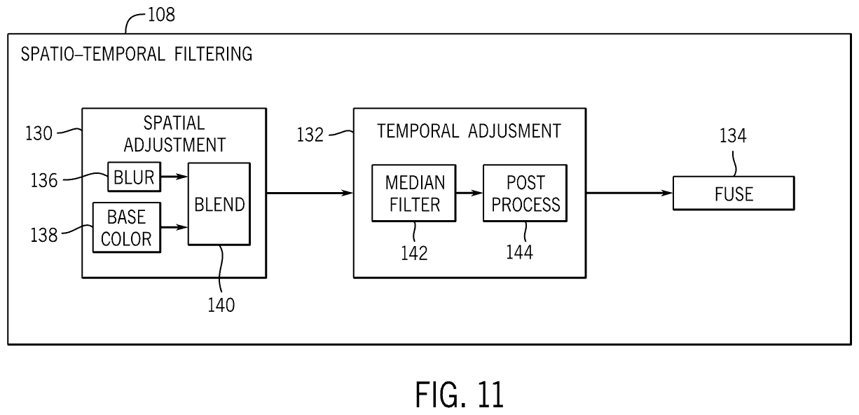

The spatio-temporal filtering circuitry 110 may fetch (e.g., retrieve) one or more source pixel values and one or more reference pixel values from the luma cache 112 and the chroma cache 114. Indeed, the spatio-temporal filtering circuitry 110 may fetch one or more source luma pixel values and one or more reference luma pixel values from the luma cache 112 and one or more source chroma pixel values and one or more reference chroma pixel values from the chroma cache 114. As an example, the spatio-temporal filtering circuitry 110 may fetch ten by ten (e.g., 10×10) source luma pixel values and four by four (e.g., 4×4) source chroma pixel values for each eight by eight (e.g., 8×8) pixel block. As another example, the spatio-temporal filtering circuitry 110 may fetch nine by nine (e.g., 9×9) reference luma pixel values and five by five (e.g., 5×5) reference chroma pixel values for each eight by eight block. Additional details regarding the spatio-temporal filtering circuitry 110 will be described below with respect to FIG. 11.

FIG. 11 is a block diagram of the spatio-temporal filtering circuitry 110 of the spatio-temporal filtering pipeline 66 of FIG. 10. The spatio-temporal filtering circuitry 110 may include spatial adjustment circuitry 130 (e.g., spatial mitigation circuitry), temporal adjustment circuitry 132 (e.g., temporal mitigation circuitry), and/or fuse circuitry 134. It should be noted that circuitry or components of the spatio-temporal filtering circuitry 110 may be implemented in hardware and/or software. The spatial adjustment circuitry 130 may include a blur component 136, a base color component 138, and/or a blend component 140. The spatial adjustment circuitry 130 may perform spatial adjustment of pixel values by employing one or more spatial characteristics of a current image frame (e.g., image frame currently being adjusted). Further, it should be noted that, in an embodiment, the spatio-temporal filtering circuitry 110 performs the adjustment of the pixel values using image data of a lower resolution than other image processing of the image frame.

The blur component 136 may receive the one or more source pixel values (e.g., the luma source pixel values from the luma cache 112 and the chroma source pixel values from the chroma cache 114). The blur component 136 may then average the one or more source pixel values. In an embodiment, the blur component 136 may employ a low-pass filter. Further, the blur component 136 may output either low-pass filtered source luma pixel values (e.g., using a three by three average filter) or the original luma source pixel values, along with the original chroma pixel values as the one or more blur pixel values.

The base color component 138 may receive (e.g., read from the DMA circuitry 39) the one or more boundary pixel values 100 and predict (e.g., interpolate) one or more pixel values within the bounding box 90 based on the one or more boundary pixel values 100. That is, each pixel inside of the bounding box 90 may be predicted (e.g., computed) by employing a weighted combination of the one or more boundary pixel values 100. Each weight on each boundary pixel value 100 of the one or more boundary pixel values 100 may be inversely proportional to a distance between a current pixel being predicted within the bounding box 90 and the boundary pixel value 100. For example, if the spatio-temporal filtering circuitry 110 is working on a pixel on a top left corner of the bounding box 90, then the most heavily weight pixel values will be the boundary pixel values 100 directly adjacent to that pixel of the bounding box 90. Therefore, base color component 138 may determine each weight of the pixel of the bounding box 90 based on a relative distance from the one or more boundary pixel values 100. In this manner, the base color component 138 may output one or more base color pixel values (e.g., one or more base color luma pixel values and one or more base color chroma pixel values).

The blend component 140 may blend the one or more blur pixel values and the one or more base color pixel values using a weighted combination, such as a base color weight. In an embodiment, the base color weight employed by the blend component 140 may be a programmable input. The blend component 140 may then output the one or more spatially adjusted pixel values (e.g., one or more spatially adjusted luma pixel values and one or more spatially adjusted chroma pixel values) to the temporal adjustment circuitry 132 and/or the fuse circuitry 134.

The temporal adjustment circuitry 132 may include a median filter component 142 (e.g., temporal filter component) and/or a post-process component 144. The temporal adjustment circuitry 132 may employ one or more temporal characteristics of the current frame and previous frames to perform temporal adjustment of pixel values. The temporal adjustment circuitry 132 may receive the spatially adjusted pixel values, one or more motion compensated pixel values of a first previous frame (e.g., previous frame from current frame by one), and/or one or more motion compensated pixel values of a second previous frame (e.g., previous frame from the current frame by two). As an example, the median filter component 142 may arrange the spatially adjusted pixel values, the one or more motion compensated pixel values of the first previous frame, and the one or more motion compensated pixel values of the second previous frame and arrange them in either an ascending or descending order. The median filter component 142 may then select a median value (e.g., middle value) of the spatially adjusted pixel values, the one or more motion compensated pixel values of the first previous frame, and the one or more motion compensated pixel values of the second previous frame to output as one or more median pixel values. For example, for the three values, the median value is the second value in the ascending or descending order.

The median filter component 142 may then provide the one or more median pixel values to the post-process component 144. The post-process component 144 may apply a weighted combination to the one or more median pixel values. For a given pixel (e.g., a current pixel being adjusted), the post-process component 144 may determine if the given pixel is inside the bounding box 90 of the first previous frame and/or the second previous frame. Thus, the post-process component 144 determines the weighted combination based on whether the given is inside the bounding box 90 of the first previous frame and/or the second previous frame. The post-process component 144 may then output one or more temporally adjusted pixel values (e.g., one or more temporally adjusted luma pixel values and one or more temporally adjusted chroma pixel values) to the fuse circuitry 134.

The fuse circuitry 134 may receive and mix (e.g., combine, merge) the one or more source pixel values, the one or more spatially adjusted pixel values, and the one or more temporally adjusted pixel values. The fuse circuitry 134 may mix the one or more source pixel values, the one or more spatially adjusted pixel values, and the one or more temporally adjusted pixel values based on a spatial weight and a bounding box weight. In an embodiment, the spatial weight and/or the bounding box weights may be programmable inputs. In another embodiment, the spatial weight and/or the bounding box weight may be computed based on statistics provided by the hierarchical motion estimation engine (e.g., of the motion estimation block 52). In yet another embodiment, the fuse circuitry 134 may receive the spatial weight and the bounding box weight from a number of registers, which may include any suitable data format for register descriptions, such as a Perl Data Structure.

After mixing the one or more source pixel values, the one or more spatially adjusted pixel values, and the one or more temporally adjusted pixel values, the fuse circuitry 134 may output one or more spatially temporally adjusted pixel values. The one or more spatially temporally adjusted pixel values may include one or more spatially temporally adjusted luma pixel values (e.g., thirty-two by thirty-two luma pixel values) and one or more spatially temporally adjusted chroma pixel values (e.g., sixteen by sixteen chroma (Cb) pixel values and sixteen by sixteen chroma (Cr) pixel values). The spatio-temporal filtering circuitry 110 may then write the one or more spatially temporally adjusted pixel values to a source frame buffer to enable the electronic device 10 to efficiently process and/or display image data associated with the one or more spatially temporally adjusted pixel values.

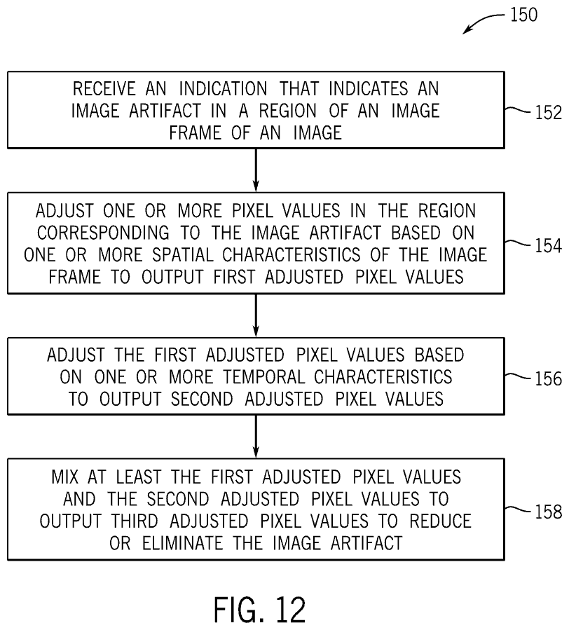

FIG. 12 is a flowchart of a method 150 for adjusting one or more pixel values based on the one or more spatial characteristics and the one or more temporal characteristics. Any suitable device that may control components of the electronic device 10, such as the processor core complex 18, may perform the adjustment of the one or more pixel values. In some embodiments, the method 150 may be implemented by executing instructions stored in a tangible, non-transitory, computer-readable medium, such as the memory 20, using the processor core complex 18. For example, the processor core complex 18 may execute instructions to cause the spatio-temporal filtering circuitry 110 to perform at least some of the steps described herein. Indeed, as an example, the method 150 may be performed by the components of the spatio-temporal filtering circuitry 110 of the electronic device 10. As another example, the method 150 may be performed at least in part by one or more software components, such as an operating system of the electronic device 10, one or more software applications of the electronic device 10, and the like. While the method 150 is described using steps in a specific sequence, it should be understood that the present disclosure contemplates that the described steps may be performed in different sequences than the sequence illustrated, and certain described steps may be skipped or not performed altogether.

At block 152, the processor core complex 18 may receive an indication that indicates the image artifact 80 in a region (e.g., portion, sub-frame) of an image frame of the image content 82. It should be noted that the region is less than a full size of the image frame. For example, the electronic device may include image artifact detection circuitry to detect the image artifact 80 and provide the indication to the processor core complex 18. At block 154, the processor core complex 18 may adjust one or more pixel values in the region corresponding to the image artifact 80 based on the one or more spatial characteristics of the image frame to output first adjusted pixel values (e.g., the one or more spatially adjusted pixel values). For example, the one or more spatial characteristics may be associated with the one or more source pixel values, the one or more boundary pixel values, and the base color weight.

At block 156, the processor core complex 18 may adjust the first adjusted pixel values based on the one or more temporal characteristics to output second adjusted pixel values (e.g., the one or more temporally adjusted pixel values). For example, the one or more temporal characteristics may be associated with the one or more motion compensated pixel values of the first previous frame and/or the one or more motion compensated pixel values of the second previous frame. The processor core complex 18 may adjust the first adjusted pixel values by using a temporal filter (e.g., the median filter component 142). At block 158, the processor core complex 18 may mix at least the first adjusted pixel values and the second adjusted pixel values to output third adjusted pixel values (e.g., the one or more spatially temporally adjusted pixel values) to reduce or eliminate the image artifact 80.

It should be noted that the method 150 may be repeated any suitable number of times based on a number of image artifacts present in various regions of the image frame. That is, the processor core complex 18 may perform the method for a first image artifact at a first time, a second image artifact at a second time (e.g., after the first time), and so on. The processor core complex 18 may repeat the method 150 until adjustment of pixel values within each of the various regions of the image artifacts has been completed. In this manner, the image artifacts present in the various regions of the image frame may be reduced or mitigated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. Image processing circuitry, comprising:
processing circuitry configured to:
receive an image;
receive an indication that indicates an image artifact in a region of an image frame of the image;
adjust one or more pixel values in the region corresponding to the image artifact based on one or more spatial characteristics of the image frame to output first adjusted pixel values;
adjust the first adjusted pixel values based on one or more temporal characteristics to output second adjusted pixel values; and
mix at least the first adjusted pixel values and the second adjusted pixel values to output third adjusted pixel values.

2. The image processing circuitry of claim 1, wherein the one or more spatial characteristics are associated with one or more source pixel values, one or more boundary pixel values, and a base color weight.

3. The image processing circuitry of claim 2, wherein the processing circuitry is configured to retrieve the one or more source pixel values from a luma cache and a chroma cache.

4. The image processing circuitry of claim 2, wherein the processing circuitry is configured to:
blur the one or more source pixel values to output one or more blur pixel values; and
predict one or more predicted pixel values within the region based on the one or more boundary pixel values to output one or more base color pixel values.

5. The image processing circuitry of claim 4, wherein the processing circuitry is configured to adjust the one or more pixel values by blending the one or more blur pixel values and the one or more base color pixel values based on the base color weight.

6. The image processing circuitry of claim 1, wherein the one or more temporal characteristics are associated with one or more motion compensated pixel values of a first previous frame and one or more motion compensated pixel values of a second previous frame.

7. The image processing circuitry of claim 6, wherein the processing circuitry is configured to adjust the first adjusted pixel values based on the one or more temporal characteristics using a temporal filter.

8. The image processing circuitry of claim 1, wherein the processing circuitry is configured to mix at least the first adjusted pixel values and the second adjusted pixel values based on a spatial weight and a bounding box weight.

9. The image processing circuitry of claim 1, wherein the one or more pixel values within the region are within a bounding box.

10. The image processing circuitry of claim 1, wherein the region is less than a full size of the received image.

11. The image processing circuitry of claim 1, wherein the processing circuitry is configured to output the third adjusted pixel values to reduce or eliminate the image artifact.

12. The image processing circuitry of claim 1, wherein the processing circuitry is configured to perform the adjustment using image data of a lower resolution than other image processing of the image frame.

13. Image processing circuitry comprising:
spatial adjustment circuitry configured to perform a spatial adjustment of image data in a region of an image frame;
temporal adjustment circuitry configured to perform a temporal adjustment of the image data in the region of the image frame; and
fuse circuitry configured to merge the spatially adjusted image data and the temporally adjusted image data in the region of the image frame.

14. The image processing circuitry of claim 13, wherein the spatial adjustment circuitry is configured to perform the spatial adjustment using a blur component, a base color component, and a blend component.

15. The image processing circuitry of claim 13, wherein the temporal adjustment circuitry is configured to perform the temporal adjustment using a filter component, wherein the filter component comprises a median filter.

16. The image processing circuitry of claim 13, wherein the image processing circuitry is configured to receive an indication that the region of the image frame comprises an image artifact.

17. The image processing circuitry of claim 13, wherein the image processing circuitry is configured to repeat the spatial adjustment and the temporal adjustment and merge the spatially adjusted image data and the temporally adjusted image data for a plurality of additional regions of the image frame.

18. Spatio-temporal filtering circuitry comprising:
spatial adjustment circuitry configured to adjust one or more pixel values in a region of an image frame corresponding to an image artifact based on one or more spatial characteristics to output one or more spatially adjusted pixel values;
temporal adjustment circuitry configured to adjust the one or more spatially adjusted pixel values based on one or more temporal characteristics to output one or more temporally adjusted pixel values; and
fuse circuitry configured to mix at least the one or more spatially adjusted pixel values and the one or more temporally adjusted pixel values in the region.

19. The spatio-temporal filtering circuitry of claim 18, wherein the spatial adjustment circuitry comprises:
a blur component configured to blur one or more source pixel values to output one or more blur pixel values;
a base color component configured to determine one or more base color pixel values based on one or more boundary pixel values; and
a blend component configured to blend the one or more blur pixel values and the one or more base color pixel values based on a base color weight to output the one or more spatially adjusted pixel values.

20. The spatio-temporal filtering circuitry of claim 18, wherein the temporal adjustment circuitry comprises a median filter component configured to filter the one or more spatially adjusted pixel values, one or more motion compensated pixel values of a first previous frame, and one or more motion compensated pixel values of a second previous frame to output one or more median pixel values.
